(19) United States
(12) Patent Application Publication
(10) Pub. No.: US 2009/0276267 A1
(43) Pub. Date: Nov. 5, 2009

(54) APPARATUS AND METHOD FOR HANDLING WEIGHT DATA RELATED TO TRANSPORTATION

(75) Inventor: Nir PADAN, Moshav Beith Itzhak (IL)

Correspondence Address: SOROKER-AGMON ADVOCATE AND PATENT ATTORNEYS, NOLTON HOUSE, 14 SHENKAR STREET, HERZELIYA PITUACH, 46725, IL

(73) Assignees: Mr. Nir PADAN, Moshav Beith Itzhak (IL); Mr. Eran SOROKER, Herzliya Pituach (IL); Mr. Jonathan AGMON, Herzliya Pituach (IL); Mr. Ady NORDMAN, Herzliya Pituach (IL)

(21) Appl. No.: 12/434,692

(22) Filed: May 4, 2009

Related U.S. Application Data
(60) Provisional application No. 61/050,258, filed on May 5, 2008.

(51) Int. Cl. G06Q 50/00; G06Q 10/00

(52) U.S. Cl. 705/7

(57) ABSTRACT

The subject matter discloses a method of handling weight data related to transportation, comprising receiving weight data from a passenger, a representative, or the passenger; accumulating the weight data associated with a specific trip and determining the amount of fuel required for the specific trip as a function of the accumulated weight data. The subject matter also discloses an apparatus for implementing the method and a method of doing business utilizing the data analyzed by the method

### BACKGROUND OF THE INVENTION

1. Field of the Invention

The present invention relates to weight data in general, and to weight data related to passengers and their luggage in particular.

2. Discussion of the Related Art

Weighing passengers and their luggage was common years ago for evaluating the total weight added to the vehicle, for example, a boat or a plane. Evaluation of the total weight is used to evaluate the amount of fuel or energy required for transporting the vehicle from one point to another. Such evaluation results in loading a relatively accurate amount of fuel or other energy source, which leads to economic benefit.

Known methods for evaluating the total weight of passengers use weight tables that contain averaged weights of different populations such as adults, male, female, adolescence, weight as a function of age and the like. Sole use of such tables may result total error of even a tone, while the legal precision level required for transportation is usually about 100 kilograms. Further, weight evaluation using such method may result in loading overhead of fuel.

U.S. Pat. No. 7,281,418 of technology patents, titled system and method of measuring weight of passengers and luggage, and weight distribution of aircraft, discloses method and/or system for operating an aircraft, using a first measuring to measure a load on front landing gear strut(s) and a second measuring for the rear landing gear strut. This measurement is performed after the luggage and the passengers are on the vehicle, and in case more fuel is required to be loaded, thus consume time while the passengers wait in the vehicle.

Other systems and methods known in the art disclose weighing passengers actively. Such systems require weights and communication modules that connect the weights to a computerized element for determining the total weight. Further, in some cases, the total sum of weights may be larger than the weight limit of the required vehicle and some of the luggage or persons may not be allowed to the vehicle. Alternatively, the passengers may have to switch to another vehicle that fits the total weight to be loaded, a time-consuming event. Obtaining the passengers' weights before the departure also provides for issuance of seats that improve stability of the vehicle in terms of spanning the weights in an efficient manner. Further, systems and methods that weigh the passengers or luggage short time before departure decreases the operator capability to precisely determine the location of the passengers in a manner that provides for balance and accurate determination of the center of gravity (C.G) parameter.

Due to logistics considerations, weighing the passengers and their luggage only short time prior to the boarding decrease operator capability to determining and load the additional weight that can be loaded to the vehicle in addition to the passengers and their weight, according to the capacity of the vehicle and the amount of fuel loaded.

A system for determining the weights required for load on a vehicle a predefined duration before departure is a long felt need.

### SUMMARY OF THE PRESENT INVENTION

It is an object of the subject matter to disclose a method of handling weight data related to transportation, comprising receiving weight data from a passenger or a representative of the passenger, accumulating the weight data associated with a specific trip and determining the amount of fuel required for the specific trip as a function of the accumulated weight data.

In some cases, the method further comprises a step of conditioning issuance of a ticket for the specific trip by receipt of the weight data.

In some cases, the method further comprises a step of determining the weight and the volume of free room in the luggage storage of the vehicle. In some cases, the method further comprises a step of determining the location of at least a portion of the passengers on the vehicle according to the weight data. In some cases, the weight data is received via a computerized environment.

In some cases, the method further comprises a step of determining the amount of fuel to be loaded to the vehicle. In some cases, the method further comprises a step of rejecting an order for a ticket to the specific trip as a function of the received weight data. In some cases, the step of receiving weight data is performed without weighing. In some cases, the method further comprises a step of determining the weight and location of additional cargo that can be loaded onto the vehicle.

It is another object of the subject matter to disclose an apparatus for associating requests and responses in a multi-tier computerized environment, comprising an I/O device for receiving weight data from a passenger or a representative or the passenger, storage for storing weight data and a processing module for accumulating the weight data and determining the amount of fuel required for a specific trip.

In some cases, the storage also comprises data associated with the specific trip and with a vehicle associated with the specific trip. In some cases, the processing module also determines the location of passengers on a vehicle associated with the specific trip to determine the desired center of gravity (C.G). In some cases, the I/O device only receives weight data until a predetermined time before the specific trip.

In some cases, the I/O device notifies the passenger or the representative of the passenger in case the weight data is not received properly. In some cases, the I/O device notifies the passenger or the representative of the passenger that a ticket to the specific trip cannot be issued in case weight data is not inputted.

It is another object of the subject matter to disclose a method of doing business, comprising receiving weight data related to a specific trip and a specific vehicle, receiving the price of the energy source used in the specific vehicle in the location of the departure, receiving the price of the energy source used in the specific vehicle in the location of the arrival and determining the amount of energy source to be loaded on the vehicle as a function of the price in the location of the departure, price in the location of the arrival and the received weight data.

In some cases, the energy source is selected from a group consisting of fuel, oil, and diesel.

### BRIEF DESCRIPTION OF THE DRAWINGS

Exemplary non-limited embodiments of the disclosed subject matter will be described, with reference to the following description of the embodiments, in conjunction with the figures. The figures are generally not shown to scale and any sizes are only meant to be exemplary and not necessarily limiting. Corresponding or like elements are designated by the same numerals or letters.

FIG. 1 shows an environment in which a person inputs weight data, according to some embodiments of the prior art;

FIG. 2 shows a computerized environment for handling weight data related to transportation, according to some embodiments of the disclosed subject matter; and,

FIG. 3 shows a flowchart of the method for handling weight data related to transportation, according to some exemplary embodiments of the subject matter.

### DETAILED DESCRIPTION OF THE PREFERRED EMBODIMENT

One technical problem addressed by the disclosed subject matter is to determine the total weight to be loaded on a vehicle without the presence of the passengers in the vicinity of the vehicle, or to determine such weight several days or hours before departure. Another technical problem is to determine the weight required without using a weight or a scale.

The technical solution disclosed in the subject matter is an interface and a computerized system enabling passengers or someone on their behalf to input weight data related to a trip. Such weight data may be sent to a computerized module associated with the vehicle or with an entity handling the transportation, for example an airport management or an aircraft company. The inputted weight data is used to determine the amount of fuel required for a specific trip, or a group of trips. Such trip may be a flight, cruise, bus ride and the like. After summing the inputted data weights, the computerized module may determine additional parameters such as the amount of additional weight allowed on the vehicle, the amount of additional fuel to be loaded on the vehicle for another trip, the locations of the passengers' seats in accordance to their weight for balance optimization and the like.

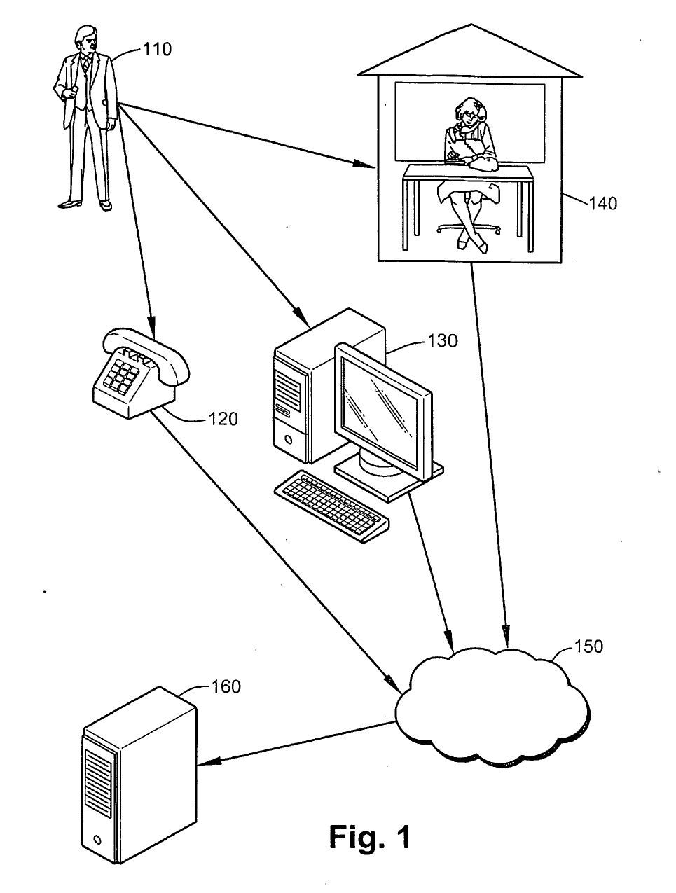

FIG. 1 shows an environment in which a person inputs weight data, according to some embodiments of the prior art. Person 110 inputs weight data to a computerized module 160 using a variety of systems or interfaces, such as a telephone 120, a computer 130 or entity 140 acting on behalf of the person 110. Weight data may be the weight of person 110, the expected weight of person's 110 luggage, or data related to the luggage, such as for example, the number, volume or size of the suitcases or bags the person 110 plans on taking. Person 110 may be a passenger, a representative of a passenger, a representative of a group of passengers, a travel agent and the like. In accordance with some exemplary embodiments of the subject matter, the person 110 can input the number of days of the planned trip and other parameters associated with the tour, and the computerized module 160 will determine the luggage weight as a function of the inputted parameters. The inputted weight data may be transmitted via network 150 to the computerized module 160. Entity 140 may be a travel agent facilitating person 110 in checking in or purchasing a ticket to the trip. In some exemplary embodiments of the subject matter; a ticket is only issued upon receipt of weight data. The vehicle may be a boat, airplane, bus, train, or any other vehicle used for transportation using which the passengers purchase tickets. The trip to which the person inputs weight data may be one-way trip, a round trip or any other type as known to a person skilled in the art. In some cases, the weight used by the computerized module 160 may be a function of the weight inputted by the person 110. The weight data may be converted into weights or another numeric value by any function desired by the person skilled in the art. The weight data may comprise weight, height, or a value selected by the person 110 from a range of values to characterize the body figure, such as slim, athletic and the like. In some exemplary embodiments of the disclosed subject matter, one or more queries are provided to person 110, a portion of the one or more queries may be multiple-choice queries, and the person is issued a ticket only upon inputting data respective to at least a portion of the one or more queries. Providing the interface or environment for inputting weight data as disclosed above enables receipt of weight data during check-in or several days before departure and enables determining the amount of fuel required for the trip a sufficient time before departure.

In some exemplary embodiments of the subject matter, network 150 connects the computerized module 160 and the person 110. Network 150 may use wired or wireless communication media, such as RF, the Internet, Intra-net, telephone network, voice over IP or the like, using commonly used protocols such as TCP, IP, IPTV or the like, or derivatives of the above. Network 150 may convert data from one communication protocol to another, or allocate bandwidth as desired or required by the communication media specifications.

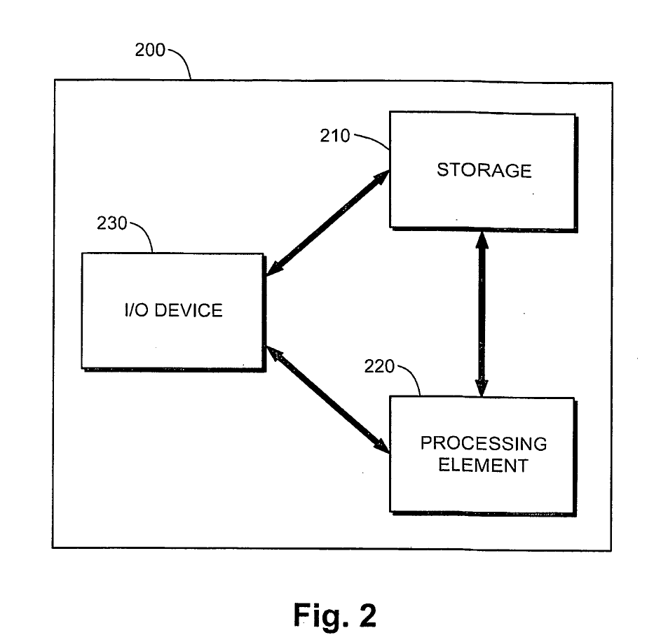

FIG. 2 shows a computerized module 200 for handling weight data related to transportation, according to some embodiments of the disclosed subject matter. Computerized module 200 comprises an I/O device 230, such as a port, that receives weight data. The weight data may be sent from the person 110 as noted above, for example via network 150. The I/O device 230 transfers the received weight data to storage 210 or to processing element 220. Storage 210 receives the weight data as well as transport data related to the weight data. Transport data may relate to the vehicle or the trip, for example the flight number, the boat type, the number of seats in the train and the like. In some exemplary embodiments, determination of fuel amount and additional parameters may be a function of the transport data.

Computerized module 200 may use, handle and analyze weight data using applications that preferably comprise software components written in any programming language such as C, C#, C++, Java, VB, VB.Net, or the like, and developed under any development environment, such as Visual Studio.Net, J2EE or the like. It will be appreciated that the server and the clients can alternatively be implemented as firmware ported for a specific processor such as digital signal processor (DSP) or microcontrollers, or can be implemented as hardware or configurable hardware such as field programmable gate array (FPGA) or application specific integrated circuit (ASIC).

In accordance with some exemplary embodiments of the disclosed subject matter, processing element 220 receives the weight data and the transport data and determines the amount of fuel required for the trip. Said amount may be determined as a function of the total sum of weight, both passengers weight and luggage weight. Processing element 220 may also determine the location or the seats to be issued to at least a portion of the passengers, or their luggage, to obtain balanced weights in different portions of the vehicle. Furthermore, after determining the location of a specific passenger in the vehicle, the processing element 220 sends the location or the seats to the I/O device 230 that sends the location or the seats to the passengers or their representatives.

Additional analysis performed by processing element 220 may relate to the amount of free room left in the luggage storage of the vehicle. This amount of free room, in terms of weight or volume, may be used to carry more luggages, for example commercial luggage not related to the passengers. In such case, the system and method for receiving and determining the amount of weight, especially luggage weight, enables for determining the amount of available extra luggage and results in increased income.

In accordance with some exemplary embodiments of the disclosed subject matter, storage 210 comprises weight data received from the person 110. Storage 210 may also contain transport data or data related to the vehicle. For example, the maximal weight allowed for the vehicle, the number or location of seats, the amount of fuel required for a certain weight loaded on the vehicle and, energy consumption as a function of weight, fuel prices the like. The data stored in storage 210 is preferably sent to processing element 220 for determining the amount of fuel required for a specific trip, or additional parameters as disclosed above, for example the location of seats issued to at least a portion of the passengers, according to their weight data, for improving the desired balance (C.G) of the vehicle.

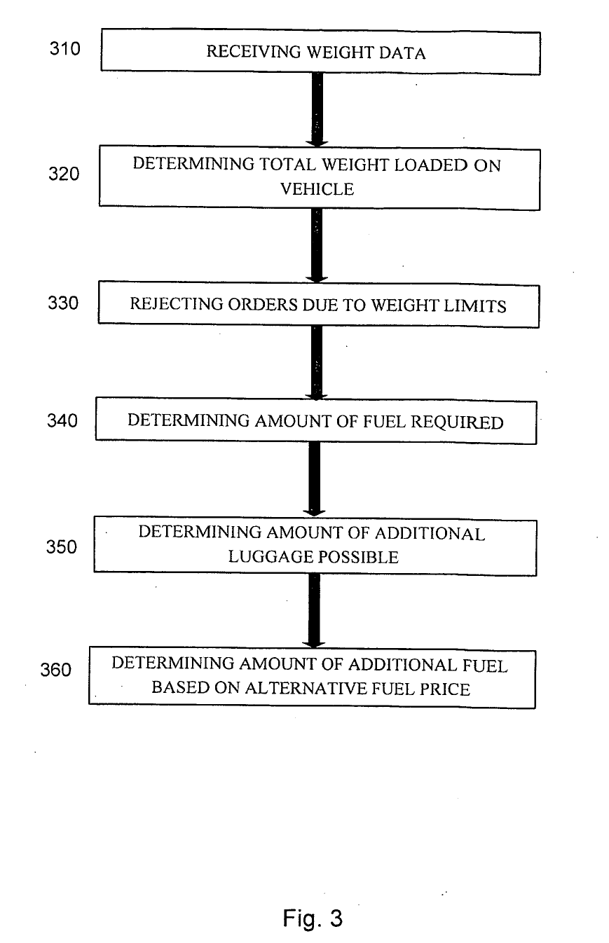

FIG. 3 shows a flowchart of the method for handling weight data related to transportation, according to some exemplary embodiments of the subject matter. The method comprises a step 310 of receiving weight data related to a passenger, luggage, group of passengers and the like. The weight data may be received via a computerized environment, messenger, a phone, a representative of the passenger and the like. The weight data may be numeric, for example a number of kilograms, or may be a reply to a multiple-choice query. In some exemplary embodiments of the disclosed subject matter, the step of receiving weight data is performed without weighing the passengers or the luggage to be loaded onto the vehicle. Step 320 discloses determining the total amount of weight to be loaded on the vehicle, for example by accumulating the received weight data. In some exemplary embodiments of the subject matter, determining the total weight comprises a step of converting weight data to weight, and accumulating weights to related to the received weight data with other weight data stored in storage 210, for example the weight of the vehicle.

On step 330, a computerized module rejects at least a portion of the orders according to the received weight data and other parameters. For example, in case the total weight determined in step 320 is higher than a predetermined value, or in case the fuel efficiency is optimal on a specific total weight loaded on the vehicle, a trip order may be rejected or modified. Alternatively, other trips may be suggested to the passenger or the representative of the passenger. The step of rejecting orders is especially new and unobvious to the method of the subject matter since it is enabled by receiving the weight data a long time before departure. On step 340, the amount of fuel to be used or to be loaded to the vehicle is determined as a function of the received weight data. Such terms and conditions used for determining the amount of fuel to be used or loaded are preferably stored on storage 210 and may vary according to the vehicle, trip, number of passengers, rate between passengers' weight and luggage weight, and the like.

On step 350, the computerized entity that received the weight data determines the amount of possible additional luggage to be loaded on the vehicle, preferably based on the total weight determined on step 320 and the total possible weight to be loaded on the vehicle as stored in storage 210. As a result, one can issue commercial orders several days before departure since the free room data is already obtained. On step 360, the computerized entity determines the amount of fuel to load on the vehicle in addition to the fuel used for a specific trip. This step may be used for optimizing outcomes after obtaining prices of energy sources in the location of the departure and the location of the arrival. Such additional fuel results in consuming more fuel during the specific trip. The computerized entity compares the prices in both locations, and the energy consumption with and without the additional fuel, and determines the amount of fuel to be loaded in addition to the amount of fuel determined on step 340, which is the amount of fuel that fits the specific trip solely.

In accordance with some exemplary embodiments of the subject matter, an additional weighing element is positioned in the vicinity of the vehicle, for verifying that the weight data previously inputted by the passengers or their representatives was correct. For example, the weighing element may be positioned near a check-in desk in an airport. Such weighing element may be hidden for not offending the passengers' privacy. The weighing element may be provided with an image capturing device such as a camera or a video camera, for detecting the number of passengers or other elements weighed by the weighing element.

One technical effect of the subject matter is to enable accurate determination of the total weight that is a crucial parameter for aircraft takeoff and landing performance, rejected takeoff, landing distance in various runway condition scenarios and the like.

Another technical effect of the subject matter is reducing fuel cost in case the passengers' weight is less than the expected average since the more fuel is loaded onto the vehicle, the more expensive is the travel.

Another technical effect of the subject matter is to enable determination of the efficient amount of cargo to be loaded onto the vehicle, especially in case the passenger's weight is less than the expected average, thus increasing income. This information, when provided a sufficient time prior to departure, allows for increasing aircraft loading efficiency.

Another technical effect of the subject matter is to enable accurate determination of the Center of gravity (C.G) by knowing the passengers weight data a predefined time before departure. Such data allows for accurate measurement of the weight distribution and the takeoff C.G. This number is crucial for takeoff calculation and drives the elevator stabilizer position. In addition, planning on aft C.G as possible (within limit) allows for increase range and endurance performance and decreases fuel consumption.

When measuring passengers weights when checking in as disclosed in prior art applications one cannot precisely control the desire CG by allocating seats as efficiently since the order of passengers affects the locations of seats provided to the passengers, while the person or computer allocating the seats is only aware of partial information. on the contrary, the disclosed subject matter received more weight data to provided enhanced seats allocation thus achieve optimize mass distribution and desired C.G.

While the disclosure has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings without departing from the essential scope thereof. Therefore, it is intended that the disclosed subject matter not be limited to the particular embodiment disclosed as the best mode contemplated for carrying out this invention, but only by the claims that follow.

1. A method of handling weight data related to transportation, comprising:
receiving weight data from a passenger or a representative of the passenger;
accumulating the weight data associated with a specific trip;
determining the amount of fuel required for the specific trip as a function of the accumulated weight data.

2. The method according to claim 1, further comprising the step of conditioning issuance of a ticket for the specific trip by receipt of the weight data.

3. The method according to claim 1, further comprising a step of determining the weight and the volume of free room in the luggage storage of the vehicle.

4. The method according to claim 1, further comprising a step of determining the location of at least a portion of the passengers on the vehicle according to the weight data.

5. The method according to claim 1, wherein the weight data is received via a computerized environment.

6. The method according to claim 1, further comprising a step of determining the amount of fuel to be loaded to the vehicle.

7. The method according to claim 1, further comprising a step of rejecting an order for a ticket to the specific trip as a function of the received weight data.

8. The method according to claim 1, wherein the step of receiving weight data is performed without weighing.

9. The method according to claim 1, further comprising a step of determining the weight and location of additional cargo that can be loaded onto the vehicle.

10. An apparatus for associating requests and responses in a multi-tier computerized environment, comprising
an I/O device for receiving weight data from a passenger or a representative or the passenger;
storage for storing weight data;
a processing module for accumulating the weight data and determining the amount of fuel required for a specific trip.

11. The apparatus of claim 10, wherein the storage also comprises data associated with the specific trip and with a vehicle associated with the specific trip.

12. The apparatus of claim 10, wherein the processing module also determines the location of passengers on a vehicle associated with the specific trip to determine the desired center of gravity (C.G).

13. The apparatus of claim 10, wherein the I/O device only receives weight data until a predetermined time before the specific trip.

14. The apparatus of claim 10, wherein the I/O device notifies the passenger or the representative of the passenger in case the weight data is not received properly.

15. The apparatus of claim 10, wherein the I/O device notifies the passenger or the representative of the passenger that a ticket to the specific trip cannot be issued in case weight data is not inputted.

16. A method of doing business, comprising:
receiving weight data related to a specific trip and a specific vehicle;
receiving the price of the energy source used in the specific vehicle in the location of the departure;
receiving the price of the energy source used in the specific vehicle in the location of the arrival;
determining the amount of energy source to be loaded on the vehicle as a function of the price in the location of the departure, price in the location of the arrival and the received weight data.

17. The method according to claim 16, wherein the energy source is selected from a group consisting of fuel, oil, and diesel.
